(19) United States
(12) Patent Application Publication
(10) Pub. No.: US 2016/0121760 A1
(43) Pub. Date: May 5, 2016

(54) ACTUATING DEVICE FOR ACTUATING AN UNLOCKING MECHANISM AND SEAT ARRANGEMENT WITH SUCH AN ACTUATING DEVICE

(71) Applicant: GM GLOBAL TECHNOLOGY OPERATIONS LLC, Detroit, MI (US)

(72) Inventors: Christian Kuhley, GroB-Gerau (DE); Jürgen Maier, Weitersweiler (DE)

(73) Assignee: GM GLOBAL TECHNOLOGY OPERATIONS LLC, Detroit, MI (US)

(21) Appl. No.: 14/927,024

(22) Filed: Oct. 29, 2015

(30) Foreign Application Priority Data
Oct. 29, 2014 (DE) 202014008604.4

(51) Int. Cl. B60N 2/08

(52) U.S. Cl. CPC B60N 2/0806; B60N 2/085

(57) ABSTRACT

An actuating device for actuating and unlocking an unlocking mechanism for a vehicle seat that can be displaced in the longitudinal direction of a vehicle. The vehicle seat is supported in a first and in a second rail assembly such that it can be displaced from a first seat position into a second seat position. The actuating device actuates the one unlocking mechanism in an active position and unlocks the vehicle seat such that it can be displaced from the first seat position into the second seat position. The actuating device includes a hand lever for transferring the actuating device from the idle position into the active position. The actuating device includes a crosstie for engaging into the first and the second rail assembly and a hand lever arranged angular to the crosstie. The hand lever and the crosstie are realized in the form of a common plastic molding.

### CROSS-REFERENCE TO RELATED APPLICATION

This application claims priority to German Patent Application No. 202014008604.4, filed Oct. 29, 2014, which is incorporated herein by reference in its entirety.

### TECHNICAL FIELD

The present disclosure pertains to an actuating device for actuating an unlocking mechanism of a vehicle seat that can be displaced in the longitudinal direction of a vehicle, as well as a seat arrangement with the vehicle seat and the actuating device.

### BACKGROUND

Nearly all vehicles feature vehicle seats that can be displaced in a longitudinal direction of the vehicle. In order to move the vehicle seat, it must be unlocked from its locked state in a certain position. For this purpose, the vehicle frequently features a lever that can be actuated by a passenger such that the vehicle seat is unlocked and can be adjusted in the longitudinal direction from one position to another position.

For example, WO 2012/118475 A1 describes a device for displacing a vehicle seat along two guide rails. The device includes several metal components including a lever to be actuated by a passenger of the vehicle and a cross brace that is supported in the guide rails. The device further includes a storage system for recording and storing the longitudinal displacement of the vehicle seat.

### SUMMARY

The present disclosure is intended to functionally improve an actuating device for actuating, particularly unlocking, at least one unlocking mechanism. The unlocking mechanism is suitable and/or designed for unlocking and/or locking a vehicle seat that can be displaced in the longitudinal direction of a vehicle, particularly a car or truck. The vehicle seat is realized, for example, in the form of a driver seat and/or front passenger seat or alternatively in the form of an occupant seat in a rear seat arrangement of the vehicle.

The vehicle seat is supported in a first rail assembly and a second rail assembly such that it can be displaced from a first seat position into a second seat position. The vehicle seat can be adjusted, in particular, in the longitudinal direction of the vehicle along the first and the second rail assembly. The first and the second rail assembly preferably extend in the longitudinal direction of the vehicle and parallel to one another.

The unlocking mechanism preferably is arranged in the first and/or the second rail assembly and/or integrated therein. The unlocking mechanism includes, for example, a first unlocking mechanism that is arranged in the first rail assembly. The unlocking mechanism optionally includes a supplementary second unlocking mechanism that is arranged in the second rail assembly.

The vehicle seat is locked in the first seat position when the actuating device assumes an idle position. The unlocking mechanism particularly locks the vehicle seat in the first seat position when the actuating device assumes the idle position. In the idle position of the actuating device, the vehicle seat especially is locked in the first and the second rail assembly by means of the unlocking mechanism and cannot be displaced in the longitudinal direction.

In an active position, the actuating device actuates the unlocking mechanism. The actuating device preferably unlocks the unlocking mechanism in the active position. The unlocking mechanism particularly is unlocked in the active position of the actuating device such that the vehicle seat is released in order to be displaced from the first seat position into the second seat position. The vehicle seat especially can be displaced in the longitudinal direction in the active position of the actuating device.

The actuating device features a hand lever that is designed for transferring the actuating device from the idle position into the active position. The hand lever is preferably actuated by a passenger, who is seated in the vehicle seat, in that the passenger pulls and/or pivots the hand lever upward, particularly in the direction of a vehicle roof. The hand lever preferably is aligned, in particular, in the longitudinal direction of the vehicle. The hand lever may optionally extend in the same direction as and/or parallel to the first and the second rail assembly. On its free end, the hand lever may feature, in particular, an actuating element such as, e.g., a handle that can be actuated by the passenger with one hand.

The actuating device includes a crosstie that is designed for engaging into the first and the second rail assembly. The actuating device particularly is supported in the first and the second rail assembly by means of the crosstie. For example, the crosstie is aligned transverse, particularly transverse to the longitudinal direction of the vehicle. The hand lever is arranged angular to the crosstie, for example rectangular. The crosstie is optionally arranged rectangular to the first and the second rail assembly.

The hand lever and the crosstie are realized in the form of a common plastic molding. For example, the actuating device, particularly the hand lever and the crosstie, can be manufactured in a common injection-molding process. It is preferred to realize the actuating device, particularly hand lever and the crosstie, in the form of one piece or one part and/or of one material.

It is advantageous that the actuating device in the form of a plastic molding has a reduced weight in comparison to the actuating device of metal described in the prior art. In this way, the energy consumption of the vehicle can be advantageously reduced. In addition, the actuating device in the form of a plastic molding can be easily and quickly manufactured in one production step. The number of required components can furthermore be reduced. Elaborate steps for assembling individual components can be eliminated. The costs and the labor for the manufacture can thereby be reduced.

In a preferred implementation of the present disclosure, the actuating device is in a top view realized in an L-shaped fashion. In this case, the hand lever preferably forms the short limb of the L-shaped plastic molding and the crosstie forms the long limb of the L-shaped plastic molding. Alternatively, the actuating device may in atop view also be realized in a T-shaped fashion. The hand lever forms the short limb of the T-shaped plastic molding and the crosstie forms the long limb of the T-shaped plastic molding.

In a preferred embodiment of the present disclosure, the crosstie includes at least one first connecting pin and at least one second connecting pin. The first connecting pin is preferably designed for connecting the crosstie to the first rail assembly. The second connecting pin is optionally designed for connecting the crosstie to the second rail assembly. The crosstie preferably can be connected to the first and the second rail assembly by means of a first coupling element, which is assigned and connected to the first rail assembly, and by mans of a second coupling element, which is assigned and connected to the second rail assembly.

For example, the first connecting pin is arranged on a first end of the crosstie and the second connecting pin is arranged on a second end of the crosstie. The first connecting pin particularly protrudes from the first end and the second connecting pin protrudes from the second end of the crosstie, especially in the form of an extension. For example, the first and the second connecting pin are realized circular in the cross section extending transverse to a longitudinal direction of the connecting pin.

It is particularly preferred that the first and the second connecting pin are integrally molded and/or injection-molded on the crosstie. The first and second connecting pin and the crosstie particularly are realized in one piece and/or of one material, especially the plastic material. In this context, it is advantageous that the first and the second connecting pin are integrally molded or injection-molded on the crosstie during the injection-molding process of the actuating device. A separate assembly can therefore be eliminated. In this way, the manufacturing and assembly time can be reduced.

According to a preferred embodiment of the present disclosure, the crosstie features at least one actuating pin that is designed for actuating the at least one unlocking mechanism. The at least one actuating pin preferably is functionally connected to the at least one unlocking mechanism. For example, the at least one actuating pin is arranged on an end of the crosstie and/or protrudes therefrom. The at least one actuating pin particularly is integrally molded and/or injection-molded on an end of the crosstie.

For example, the at least one actuating pin includes a first actuating pin that is designed for actuating the first unlocking mechanism. The at least one actuating pin optionally includes a supplementary second actuating pin that is designed for actuating the second unlocking mechanism.

In a preferred constructive implementation of the present disclosure, the at least one actuating pin, particularly the first and/or the second actuating pin, is realized in a U-shaped fashion in the cross section extending transverse to a longitudinal direction of the actuating pin. This advantageously makes it possible to save plastic material during the manufacture. In the context of the present disclosure, it is alternatively also possible that the first and the second actuating pin are realized rectangular and/or square in said cross section.

The seat arrangement includes the vehicle seat, the at least one unlocking mechanism for unlocking the vehicle seat and the first and the second rail assembly. The seat arrangement optionally features the at least one supplementary coupling element for coupling the crosstie to the first and the second rail assembly. It is particularly preferred that the vehicle seat is screwed to the first and the second slide rail such that it can be displaced along the first and the second bearing rail together with said slide rails.

In a preferred embodiment of the present disclosure, the crosstie extends transverse to the longitudinal direction of the vehicle between the first and the second rail assembly. The hand lever preferably extends parallel to the longitudinal direction of the vehicle. The first and the second rail assembly and optionally the hand lever particularly are aligned parallel to one another. The crosstie particularly extends rectangular to the first and the second rail assembly.

It is particularly preferred that the first rail assembly includes a first slide rail and a first bearing rail. For example, the first bearing rail is designed for being supported and mounted on a vehicle floor of the vehicle. The first slide rail preferably is inserted into the first bearing rail and can be displaced therein in the longitudinal direction when the actuating device assumes the active position. The second rail assembly preferably includes a second slide rail and a second bearing rail. The second bearing rail particularly is designed for being supported and mounted on the vehicle floor. The second slide rail especially is inserted into the second bearing rail and can be displaced therein in the longitudinal direction when the actuating device assumes the active position.

In a preferred implementation of the present disclosure, the seat arrangement includes the first and the second coupling element. The first coupling element preferably couples the crosstie to the first slide rail and the second coupling element couples the crosstie to the second slide rail. For example, the first and the second coupling element are screwed to the corresponding slide rail for this purpose. The first coupling element particularly is arranged between the first connecting pin and the first slide rail and the second coupling element is arranged between the second connecting pin and the second slide rail, wherein the respective connecting pin engages into the corresponding coupling element.

According to a potential implementation of the present disclosure, the at least one unlocking mechanism is arranged in the first and/or second rail assembly and/or integrated therein. The first unlocking mechanism particularly is assigned to the first rail assembly and the second unlocking mechanism is assigned to the second rail assembly. The first bearing rail preferably includes the first unlocking mechanism. The first unlocking mechanism preferably is designed for unlocking the vehicle seat relative to the first rail assembly in the active position of the actuating device. The second bearing rail optionally includes the supplementary second unlocking mechanism. In this case, the second unlocking mechanism is designed for unlocking the vehicle seat relative to the second rail assembly in the active position of the actuating device. In this way, the first slide rail can be displaced in the first bearing rail and the second slide rail can be displaced in the second bearing rail. The vehicle seat particularly can be longitudinally displaced from the first into the second seat position and/or vice versa.

The unlocking mechanism is realized, e.g., in the form of a stud that preferably extends vertically upward from the respective bearing rail and through an opening in the slide rail. The stud preferably can be pressed and/or displaced downward, particularly in the direction of the vehicle floor, in order to unlock the slide rail and the vehicle seat. The slide rail and the vehicle seat particularly are locked when the stud protrudes upward through the slide rail and/or is not pressed and/or displaced downward.

In a preferred embodiment of the present disclosure, the at least one actuating pin actuates the at least one unlocking mechanism when the actuating device is in the active position. The first actuating pin particularly unlocks the first unlocking mechanism in the active position of the actuating device. The second actuating pin optionally unlocks the supplementary second unlocking mechanism when the actuating device is in the active position. The at least one actuating pin preferably features a contact surface, by means of which it contacts, particularly actuates and/or unlocks, an opposite contact surface of the at least one unlocking mechanism in the active position of the actuating device. The contact surface is realized, for example, complementary to the opposite contact surface. The contact surface and the opposite contact surface particularly are realized complementary to one another and/or adapted to one another. The opposite contact surface especially has a negative shape and the contact surface has a matching positive shape. In this way, an effective actuation of the at least one unlocking mechanism by mans of the at least one actuating pin can be ensured. A first contact surface of the first actuating pin preferably is realized complementary to the opposite contact surface of the first unlocking mechanism and a second contact surface of the second actuating pin is realized complementary to the opposite contact surface of the second unlocking mechanism.

In a preferred implementation of the present disclosure, the seat arrangement features a first sliding bearing assembly and a second sliding bearing assembly for pivotably supporting the crosstie, particularly the first and the second connecting pin. For example, the first sliding bearing assembly is attached to the end of the first connecting pin and the second sliding bearing assembly is attached to the end of the second connecting pin. The crosstie preferably is pivotably supported in the first and the second sliding bearing assembly, particularly by means of the first and the second connecting pin.

For example, the crosstie is pivoted about its longitudinal axis in the first and the second sliding bearing when the actuating device is transferred from the idle position into the active position. When the hand lever is actuated, the actuating device preferably is transferred from the idle position into the active position and the crosstie is pivoted about its longitudinal axis in the first sliding bearing assembly by means of the first connecting pin and in the second sliding bearing assembly by means of the second connecting pin. Due to this pivoting motion, the at least one actuating in on the crosstie is positioned in such a way that it unlocks the at least one unlocking mechanism.

The crosstie preferably is connected in a torque-proof fashion to the first slide rail by means of the first sliding bearing assembly and to the second slide rail by means of the second sliding bearing assembly. It is particularly preferred that the first sliding bearing assembly is positively connected to the first slide rail and the second sliding bearing assembly is positively connected to the second slide rail.

It is particularly preferred that the crosstie is connected to the first and the second slide rail by means of the first and the second coupling element. The first sliding bearing assembly preferably engages into the first coupling element and the second sliding bearing assembly engages into the second coupling element and is respectively supported therein in a torque-proof fashion, particularly in a positive fashion. The first and the second coupling element are preferably realized in the form of a metal component, particularly in the form of a stamping and/or a bent component.

In a preferred embodiment of the present disclosure, the seat arrangement features at least one transport and/or installation safeguard. For example, the transport and/or installation safeguard is designed for preventing transport and/or installation damages to the first and the second rail assembly. In its activated position, the transport and/or installation safeguard prevents, for example, an inadvertent actuation of the at least one unlocking mechanism during the transport and/or during the installation, particularly prior to the completion of the seat arrangement. It would also be conceivable that the at least one actuating pin is blocked by the transport and/or installation safeguard and therefore cannot actuate the unlocking mechanism. After the completion of the seat arrangement, the transport and/or installation safeguard preferably is deactivated by a worker such that the at least one unlocking mechanism or the actuating pin is once again functional.

The transport and/or installation safeguard is arranged, for example, on the first and/or on the second connecting pin and simultaneously on the at least one unlocking pin. The installation safeguard is optionally pushed over the first and the second connecting pin and over the at least one unlocking pin.

In another potential implementation of the present disclosure, the seat arrangement features at least one spring element. The at least one spring element preferably is designed for resetting the actuating device automatically and/or in an assisted fashion. For example, the at least one spring element is arranged on the first and/or on the second connecting pin, particularly placed thereon, and braced against the respective slide rail and/or against the respective coupling element. Simple and convenient handling of the actuating device can be ensured with the at least one spring element.

### BRIEF DESCRIPTION OF THE DRAWINGS

The present disclosure will hereinafter be described in conjunction with the following drawing figures, wherein like numerals denote like elements.

FIG. 1 shows a perspective top view of a seat arrangement with an actuating device and a first and a second rail assembly;

FIG. 2 shows the actuating device according to FIG. 1 with a hand lever and a crosstie; and

FIG. 3 shows a detail of a first end of the crosstie according to FIG. 2.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

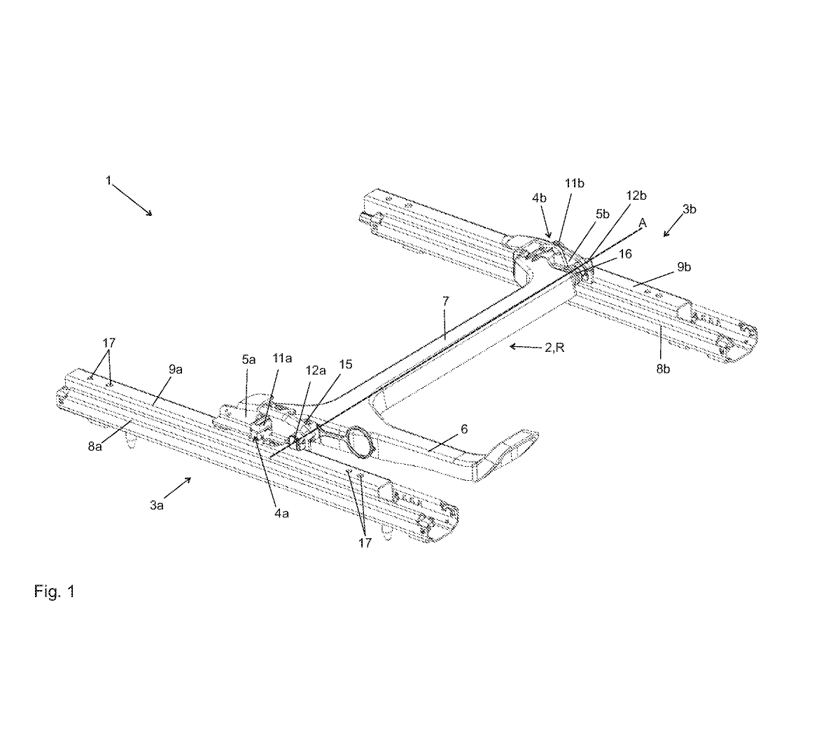

FIG. 1 shows a seat arrangement 1 for a vehicle, particularly for a car or a truck. The seat arrangement 1 includes a vehicle seat (not shown) that is realized, for example, in the form of a driver or front passenger seat or in the form of a seat of a rear seat arrangement of the vehicle. The vehicle seat can be displaced along a first and a second rail assembly 3a; 3b of the seat arrangement 1.

The first and the second rail assembly 3a, 3b both extend in the longitudinal direction L of the vehicle and are arranged, in particular, parallel to one another. The first and the second rail assembly 3a; 3b are designed for mounting the vehicle seat on a vehicle floor. For this purpose, the first rail assembly 3a includes a first bearing rail 8a and the second rail assembly 3b includes a second bearing rail 8b, wherein said bearing rails are designed for being supported and mounted on the vehicle floor.

The first rail assembly 3a features a first slide rail 9a and the second rail assembly 3b features a second slide rail 9b. The first slide rail 9a is inserted into the first bearing rail 8a and the second slide rail 9b is inserted into the second bearing rail 8b and locked in a first position of the vehicle seat. When the slide rails 9a; 9b are unlocked, they can be displaced in the bearing rails 8a; 8b along the longitudinal direction thereof.

The two slide rails 9a; 9b feature several holes 17 for mounting the vehicle seat on the first and the second rail assembly 3a; 3b and for producing the connection with the vehicle floor. For example, the vehicle seat may be screwed to the first and the second slide rail 9a; 9b. The vehicle seat is thereby fixed in the first seat position in the locked state of the slide rails 9a; 9b. When the slide rails 9a, 9b are unlocked, the vehicle seat can be displaced in the longitudinal direction L of the vehicle, particularly from the first seat position into a second seat position, together with the slide rails.

The seat arrangement 1 features an actuating device 2 and a first and a second unlocking mechanism 4a; 4b. The first unlocking mechanism 4a is arranged and/or integrated in the first rail assembly 3a and the second unlocking mechanism 4b is arranged and/or integrated in the second rail assembly 3b. The first unlocking mechanism 4a is designed for unlocking and/or locking the first slide rail 9a and the second unlocking mechanism 4b is designed for unlocking and/or locking the second slide rail 9b.

The actuating device 2 is connected to the first rail assembly 3a by means of a first coupling element 5a of the seat arrangement 1 and to the second rail assembly 3b by means of a second coupling element 5b of the seat arrangement 1. The first coupling element 5a is arranged on and/or connected to the first slide rail 9a and the second coupling element 5b is arranged on and/or connected to the second slide rail 9b. The first and the second coupling element 5a, 5b are realized in the form of metal components, particularly in the form of stampings and/or bent components.

The actuating device 2 is designed for actuating and/or unlocking the first and the second unlocking mechanism 4a; 4b. The first and the second slide rail 9a; 9b particularly are unlocked and/or released in order to be displaced when the actuating device 2 actuates and/or unlocks the first and the second unlocking mechanism 4a; 4b. For this purpose, the actuating device 2 can be transferred from an idle position R into a (not-shown) active position. In the idle position R, the first and the second unlocking mechanism 4a; 4b are not actuated and the vehicle seal is fixed in the first or the second seat position. In the active position of the actuating device 2, the first and the second unlocking mechanism 4a; 4b are actuated and/or unlocked such that the slide rails 9a; 9b and therefore the vehicle seat are released and can be displaced from the first into the second seat position or vice versa.

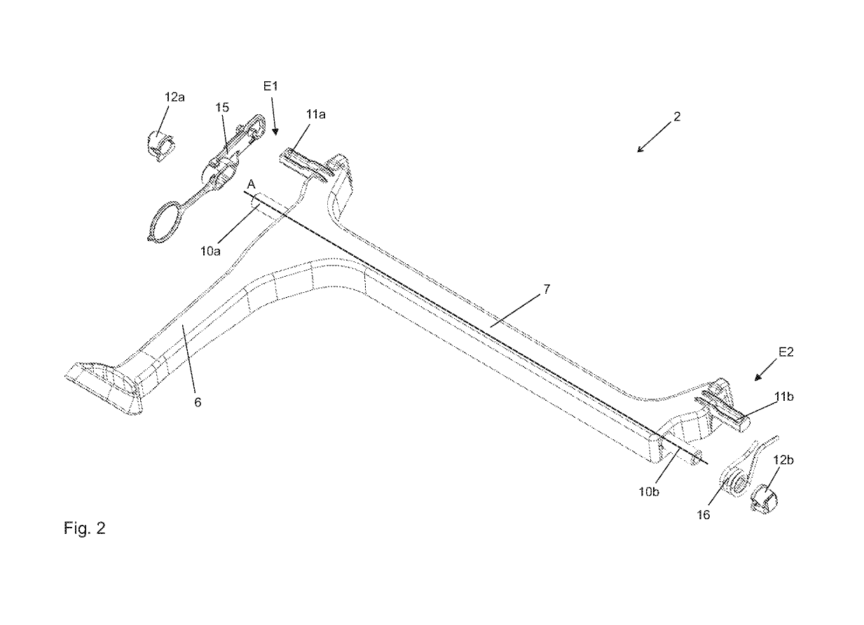

FIG. 2 shows the actuating device 2 in the form of a perspective top view. The actuating device 2 features a hand lever 6 and a crosstie 7. The hand lever 6 and the crosstie 7 are realized in the form of a common plastic molding. They are manufactured in one piece or in one part and/or of one plastic material in a common injection molding process. In a top view, the actuating device 2 is realized in an L-shaped fashion. The hand lever 6 forms the short limb of the L and the crosstie 7 forms the long limb.

According to FIG. 1, the hand lever 6 is aligned in the longitudinal direction L of the vehicle. The hand lever 6 is optionally aligned in the same direction as the first and the second rail assembly 3a, 3b, particularly parallel thereto. The crosstie 7 is aligned transverse and/or angular, particularly rectangular, to the longitudinal direction L of the vehicle and/or to the first and the second rail assembly 3a; 3b. The crosstie 7 is arranged between the first and the second rail assembly 3a, 3b and connected thereto with its ends.

When a passenger of the vehicle, who is seated in the vehicle seat, pulls the hand lever 6 upward in the direction of the vehicle roof, the actuating device 2 is pivoted about a pivoting axis A, which extends in the same direction as and/or parallel to the longitudinal axis of the crosstie 7, and transferred from the idle position R into the active position.

According to FIGS. 1 and 2, the actuating device 2 features a first and a second connecting pin 10a; 10b. The first and the second connecting pin 10a, 10b are realized circular in the cross section, in which the line of section extends in the longitudinal direction L of the vehicle.

The first and the second connecting pin 10a, 10b consist of the plastic material and are manufactured together with the actuating device 2 in a common injection-molding process. The first and the second connecting pin 10a; 10b particularly are integrally molded and/or injection-molded on the ends of the crosstie 7. The first connecting pin 10a is arranged on a first end E1 of the crosstie 7 and the second connecting pin 10b is arranged on a second end E2 of the crosstie 7. Both connecting pins 10a; 10b protrude from the respective ends E1; E2 of the crosstie 7 in the longitudinal direction of the crosstie 7.

The actuating device 2, particularly the crosstie 7, is connected to the first rail assembly 3a by means of the first connecting pin 10a and to the second rail assembly 3b by means of the second connecting pin 10b. For this purpose, the first connecting pin 10a engages into the first coupling element 5a that is connected to the first rail assembly 3a. The second connecting pin 10 engages into the second coupling element 5b that is connected to the second rail assembly 3b. The actuating device 2 features a first actuating pin 11a for contacting and actuating the first unlocking mechanism 4a and a second actuating pin 11b for contacting and actuating the second unlocking mechanism 4b. The first and the second actuating pin 11a, 11b are realized in a U-shaped fashion in the cross section, in which the line of section extends in the longitudinal direction L of the vehicle.

The first and the second actuating pin 11a, 11b consist of the plastic material and are integrally injection-molded and/or molded on the ends of the crosstie 7 in a common injection-molding process. In this case, they are arranged at the same height referred to the corresponding connecting pin 10; 10b and/or spaced apart therefrom. The first actuating pin 11a is arranged on the first end E1 of the crosstie 7 and the second actuating pin 11b is arranged on the second end E2 of the crosstie 7. Both actuating pins 11a; 11b protrude from the ends E1; E2 of the crosstie 7 in the longitudinal direction of the crosstie 7.

The seat arrangement 1 includes a first and a second sliding bearing assembly 12a, 12b. The first and the second sliding bearing assembly 12a, 12b are realized in the form of sliding bars. The first sliding bearing assembly 12a is attached to the end of the first connecting pin 10a and the second sliding bearing assembly 12b is attached to the end of the second connecting pin 10b. The connecting pins 10a; 10b can be pivoted in the sliding bearing assemblies 12a; 12b. The pivoting axis A of the actuating device 2 therefore corresponds to a longitudinal axis of the connecting pins 10a; 10b. The crosstie 7 particularly is pivotably supported in the first and the second sliding bearing assembly 12a, 12b.

The seat arrangement 1 includes a spring element 16 that is designed for resetting the actuating device 2 automatically and/or in an assisted fashion. The spring element 16 particularly ensures that the slide rail and therefore the vehicle seat can be locked in an easily manageable fashion after the vehicle seat has been displaced from the first into the second seat position or vice versa.

The spring element 16 is arranged on the second connecting pin 10b, particularly placed thereon. It is braced against the second slide rail 9b and/or against the second coupling element 5b. The spring element 16 may alternatively also be arranged on the first connecting pin 10a and fulfill its function at this location. It would also be conceivable that the seat arrangement 1 features two spring elements that are respectively placed on the ends of the connecting pins 10a; 10b.

The seat arrangement 1 includes a transport and/or installation safeguard 15 that is realized on the rail assemblies 3a, 3b and/or on the unlocking mechanisms 4a; 4b in order to prevent transport and/or installation damages. The transport and/or installation safeguard 15 particularly prevents the rail assemblies 3a; 3b from being inadvertently displaced before they are mounted on the vehicle floor. The transport and/or installation safeguard 15 optionally prevents the first and/or the second unlocking mechanism 4a, 4b from being inadvertently actuated during the transport and/or during the installation, particularly prior to the completion of the seat arrangement 1.

The transport and/or installation safeguard 15 remains in the vehicle after the seal arrangement 1 has been installed therein. It is switched into a deactivated position by a worker such that the first and the second unlocking mechanism 4a, 4b can be actuated and/or unlocked when the actuating device 2 is transferred from the idle position R into the active position.

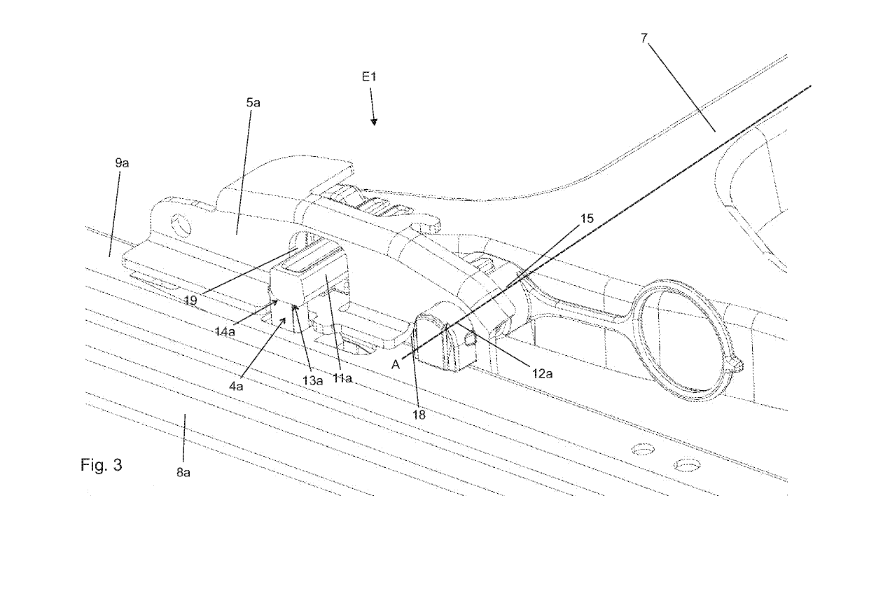

FIG. 3 shows a detail of the first end E1 of the crosstie 7. The following description optionally applies analogously to the second end E2 of the crosstie 7. The first coupling element 5a is connected to the first slide rail 9a such that it can be displaced together with this slide rail in the active position of the actuating device 2. The first coupling element 5a features a recess 18, into which the first connecting pin 10a engages with the sliding bearing assembly 12a placed on the end thereof such that the first connecting pin is arranged in the recess in a torque-proof fashion. In this way, the actuating device 2 is supported in the first coupling element 5a in a torque-proof fashion, particularly in a positive fashion, by means of the first connecting pin 10a and by means of the first sliding bearing assembly 12a. The first coupling element 5a features a second recess 19, through which the first actuating pin 11a protrudes such that it is arranged above and overlapping with the first unlocking mechanism 4a.

During the transfer of the actuating device 2 from the idle position R into the active position, the actuating device 2 pivots about the pivoting axis A in the sliding bearings 12a, 12b, particularly with the connecting pins 10a, 10b. This causes the first actuating pin 11a to be moved in the direction of the first locking mechanism 4a. The first actuating pin 11a features a first contact surface 13a, by means of which it contacts an opposite contact surface 14a of the first unlocking mechanism 4a. The first contact surface 13a and the first opposite contact surface 14a are realized complementary to one another. The first contact surface 13a particularly has a negative shape referred to the opposite contact surface 14a, which has a positive shape. In this way, a reliable actuation and/or unlocking of the first unlocking mechanism 4a can be ensured.

In the active position of the actuating device 2, the first actuating pin 11a presses against the first opposite contact surface 14a of the first unlocking mechanism 4a with its first contact surface 13a. This causes the first unlocking mechanism 4a to be actuated and/or unlocked such that the first slide rail 9a and therefore the vehicle seat can be displaced in the longitudinal direction L of the vehicle along the first bearing rail 8a. The vehicle seat therefore can be displaced from the first into the second seat position or vice versa in the active position of the actuating device 2.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A vehicle seat assembly having a vehicle seat that can be displaced in the longitudinal direction of a vehicle, the vehicle seat assembly comprising:
a rail assembly slidably positionable between a first seat position and a second seat position;
an unlocking mechanism operable in a locked state to lock the rail assembly in one of the first and second seat positions and in an unlocked state to unlock the rail assembly for positioning between the first and second seat position;
an actuating device having an actuator operably coupled to the unlocking mechanism, wherein the unlocking mechanism is in the locked state when the actuating device is in a first position and in the unlocked state when the actuating device is in a second position, the actuating device further including a hand lever configured to transfer the actuator from the first position into the second position and a crosstie configured to engage the first and the second rail assembly, wherein the hand lever is arranged angular to the crosstie, and the hand lever and the crosstie are realized in the form of a common plastic molding.

17. The vehicle seat assembly according to claim 16, wherein the actuating device is in a top view realized in an L-shaped fashion, and wherein the hand lever forms a short limb of the L-shaped plastic molding, and the crosstie forms a long limb of the L-shaped plastic molding.

18. The vehicle seat assembly according to claim 16, wherein the rail assembly comprises a first rail and a second rail, and wherein the crosstie includes a first pin arranged on and protrudes from a first end of the crosstie and connecting the crosstie to the first rail and a second pin arranged on and protrudes from a second end of crosstie and connecting the crosstie to the second rail.

19. The vehicle seat assembly according to claim 18, wherein the crosstie comprises at least one actuating pin arranged on an end of the crosstie for actuating the one unlocking mechanism.

20. The vehicle seat assembly according to claim 19, wherein the at least one actuating pin comprises an element which is U-shaped in a horizontal cross section, in which the line of section extends in the longitudinal direction of the vehicle.

21. The vehicle seat arrangement according to claim 18, wherein the crosstie extends transverse to the longitudinal direction of the vehicle between the first and the second rails, and wherein the hand lever extends parallel to the longitudinal direction of the vehicle.

22. The vehicle seat arrangement according to claim 18, wherein the rail assembly includes a first bearing rail, a first slide rail slideably supported in the first bearing rail, a second bearing rail, and a second slide rail slideably supported in the second bearing rail, and wherein the first slide rail can be displaced in the first bearing rail and the second slide rail can be displaced in the second bearing rail when the actuating device assumes the second position.

23. The vehicle seat arrangement according to claim 22, wherein the unlocking mechanism is operably coupled to the first and second rails, and wherein the first and second pins unlocks the unlocking mechanism in the second position of the actuating device such that the first slide rail can be displaced in the first bearing rail and the second slide rail can be displaced in the second bearing rail for transferring the vehicle seat between the first into the second seat position.

24. The vehicle seat arrangement according to claim 23, wherein the first and second pins comprise a contact surface configured to complement an opposite contact surface of the unlocking mechanism.

25. The vehicle seat arrangement according to claim 24, wherein the seat arrangement further comprises a first sliding bearing assembly attached to the end of the first pin and a second sliding bearing assembly attached to an end of the second pin, and wherein the crosstie is pivotably supported in the first and the second sliding bearing assembly by the first and second pins.

26. The vehicle seat arrangement according to claim 25, wherein the crosstie is in the active position of the actuating device pivoted about a pivoting axis in the first sliding bearing assembly by the first pin and in the second sliding bearing assembly by the second pin, and wherein the pivoting axis is aligned parallel to the longitudinal direction of the crosstie.

27. The vehicle seat arrangement according to claim 26, wherein the crosstie is connected to the first slide rail in a torque-proof fashion by the first sliding bearing assembly, and wherein the crosstie is connected to the second slide rail in a torque-proof fashion by the second sliding bearing assembly.

28. The vehicle seat arrangement according to claim 27, further comprising a transport safeguard arranged on the first and second pins and simultaneously on the first and the at least one actuating pin and configured to prevent transport damage to at least one of the first rail.

29. The vehicle seat arrangement according to claim 28, further comprising at least one spring element arranged on at least one of the first and second pins for resetting the actuating device in an assisted fashion.
